(19) United States
(12) Patent Application Publication
(10) Pub. No.: US 2013/0236225 A1
(43) Pub. Date: Sep. 12, 2013

(54) FIXING DEVICE AND IMAGE FORMING APPARATUS INCORPORATING SAME

(71) Applicants: Tadashi OGAWA, Tokyo (JP); Masaaki YOSHIKAWA, Tokyo (JP); Kenji ISHII, Kanagawa (JP); Teppei KAWATA, Kanagawa (JP); Arinobu YOSHIURA, Kanagawa (JP); Toshihiko SHIMOKAWA, Kanagawa (JP); Kensuke YAMAJI, Kanagawa (JP); Yuji ARAI, Kanagawa (JP); Yoshiki YAMAGUCHI, Kanagawa (JP); Hiromasa TAKAGI, Tokyo (JP); Naoki IWAYA, Tokyo (JP); Takahiro IMADA, Kanagawa (JP); Hajime GOTOH, Kanagawa (JP); Akira SUZUKI, Tokyo (JP)

(72) Inventors: Tadashi OGAWA, Tokyo (JP); Masaaki YOSHIKAWA, Tokyo (JP); Kenji ISHII, Kanagawa (JP); Teppei KAWATA, Kanagawa (JP); Arinobu YOSHIURA, Kanagawa (JP); Toshihiko SHIMOKAWA, Kanagawa (JP); Kensuke YAMAJI, Kanagawa (JP); Yuji ARAI, Kanagawa (JP); Yoshiki YAMAGUCHI, Kanagawa (JP); Hiromasa TAKAGI, Tokyo (JP); Naoki IWAYA, Tokyo (JP); Takahiro IMADA, Kanagawa (JP); Hajime GOTOH, Kanagawa (JP); Akira SUZUKI, Tokyo (JP)

(21) Appl. No.: 13/771,467

(22) Filed: Feb. 20, 2013

(30) Foreign Application Priority Data
Mar. 9, 2012 (JP) 2012-053106

(51) Int. Cl. G03G 15/20

(52) U.S. Cl. CPC G03G 15/2064
USPC 399/329; 399/323

(57) ABSTRACT

A fixing device includes an endless belt and a pressing body pressed against the endless belt to form a fixing nip therebetween through which a recording medium is conveyed. A separator contacts and separates the recording medium discharged from the fixing nip from the endless belt. The separator includes a center plate disposed opposite a center of the endless belt in an axial direction thereof to contact the recording medium and a lateral end plate disposed opposite each lateral end of the endless belt in the axial direction thereof and including a contact portion projecting beyond the center plate toward the endless belt and contacting the endless belt to produce a given interval between the center plate and the endless belt.

### CROSS-REFERENCE TO RELATED APPLICATION

This patent application is based on and claims priority pursuant to 35 U.S.C. §119 to Japanese Patent Application No. 2012-053106, filed on Mar. 9, 2012, in the Japanese Patent Office, the entire disclosure of which is hereby incorporated by reference herein.

### BACKGROUND OF THE INVENTION

1. Field of the Invention

Example embodiments generally relate to a fixing device and an image forming apparatus, and more particularly, to a fixing device for fixing a toner image on a recording medium and an image forming apparatus incorporating the fixing device.

2. Description of the Related Art

Related-art image forming apparatuses, such as copiers, facsimile machines, printers, or multifunction printers having at least one of copying, printing, scanning, and facsimile functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a development device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

FIG. 1 illustrates one example of such fixing device. As shown in FIG. 1, a fixing device 20R1 includes a fixing belt 1j stretched across a heating roller 1d and a fixing roller 1b. A pressing roller 1a is pressed against the fixing roller 1b via the fixing belt 1j to form a fixing nip N between the pressing roller 1a and the fixing belt 1j. The fixing belt 1j is heated by a heater 1f disposed inside the heating roller 1d. As the pressing roller 1a rotating clockwise and the fixing belt 1j rotating counterclockwise in FIG. 1 convey a recording medium P bearing a toner image T through the fixing nip N, the fixing belt 1j and the pressing roller 1a apply heat and pressure to the recording medium P, thus fixing the toner image T on the recording medium P.

However, since the fixing roller lb incorporates a rubber layer having an increased thermal capacity that draws heat from the fixing belt 1j, it takes substantial time to warm up the fixing belt 1j to a given fixing temperature to fix the toner image T on the recording medium P.

To address this problem, a fixing device incorporating a ceramic heater having a reduced thermal capacity is proposed. FIG. 2 illustrates a fixing device 20R2 incorporating a ceramic heater 2f that presses against a pressing roller 2a via a fixing belt 2j to form a fixing nip N between the fixing belt 2j and the pressing roller 2a. As the pressing roller 2a rotating clockwise and the fixing belt 2j rotating counterclockwise in FIG. 2 convey a recording medium P bearing a toner image T through the fixing nip N, the fixing belt 2j and the pressing roller 2a apply heat and pressure to the recording medium P, thus fixing the toner image T on the recording medium P. Since the ceramic heater 2f having a reduced thermal capacity directly heats the fixing belt 2j, that is, a film also having a reduced thermal capacity, the fixing belt 2j is heated to the fixing temperature quickly with reduced power.

However, since the fixing belt 2j is heated by the ceramic heater 2f at the fixing nip N only, the fixing belt 2j is cool at a position immediately upstream from the fixing nip N in the direction of rotation of the fixing belt 2j. Accordingly, at an entry to the fixing nip N, the fixing belt 2j may not be heated to the fixing temperature, resulting in fixing failure that may arise due to a decreased temperature of the fixing belt 2j.

To address this problem, a configuration in which a heater disposed inside a fixing belt heats the fixing belt entirely is proposed. For example, a tubular metal thermal conductor disposed inside the fixing belt presses against a pressing roller via the fixing belt. The heater is disposed inside the metal thermal conductor. As the metal thermal conductor is heated by the heater disposed inside it, the metal thermal conductor disposed opposite the entire inner circumferential surface of the fixing belt heats the entire fixing belt quickly.

On the other hand, the fixing devices described above may include a separator situated downstream from the fixing nip N in the direction of rotation of the fixing belt to contact and separate the recording medium P discharged from the fixing nip N from the fixing belt. For example, the separator should be spaced apart from the fixing belt with a given interval therebetween to facilitate separation of the recording medium P from the fixing belt without damaging the fixing belt. However, the interval may be uneven or eliminated as the fixing belt is deformed by fluctuations in operation and environment of the fixing device. Accordingly, the recording medium P may be wound around the fixing belt or the separator may come into contact with the fixing belt, resulting in faulty separation of the recording medium P from the fixing belt and damage to the fixing belt.

### SUMMARY OF THE INVENTION

At least one embodiment may provide a fixing device that includes a flexible endless belt rotatable in a given direction of rotation. A nip formation pad is disposed opposite an inner circumferential surface of the endless belt. A pressing body is pressed against the nip formation pad via the endless belt to form a fixing nip between the pressing body and the endless belt through which a recording medium is conveyed. A flange contacts and supports the endless belt. A separator is movably supported by the flange to contact and separate the recording medium discharged from the fixing nip from the endless belt. The separator includes a center plate disposed opposite a center of the endless belt in an axial direction thereof to contact the recording medium and a lateral end plate disposed opposite each lateral end of the endless belt in the axial direction thereof and including a contact portion projecting beyond the center plate toward the endless belt and contacting the endless belt to produce a given interval between the center plate and the endless belt.

At least one embodiment may provide an image forming apparatus including the fixing device described above.

Additional features and advantages of example embodiments will be more fully apparent from the following detailed description, the accompanying drawings, and the associated claims.

### BRIEF DESCRIPTION OF THE SEVERAL VIEWS OF THE DRAWINGS

A more complete appreciation of example embodiments and the many attendant advantages thereof will be readily obtained as the same becomes better understood by reference to the following detailed description when considered in connection with the accompanying drawings, wherein:

FIG. 1 is a vertical sectional view of a first related-art fixing device;

FIG. 2 is a vertical sectional view of a second related-art fixing device;

FIG. 3 is a schematic vertical sectional view of an image forming apparatus according to an example embodiment of the present invention;

FIG. 4 is a vertical sectional view of a fixing device according to a first example embodiment of the present invention that is installed in the image forming apparatus shown in FIG. 3;

FIG. 5 is a perspective view of the fixing device shown in FIG. 4;

FIG. 6 is a partial perspective view of a fixing device according to a second example embodiment of the present invention that is installable in the image forming apparatus shown in FIG. 3;

FIG. 7 is a vertical sectional view of a fixing device as a variation of the fixing device shown in FIG. 4; and

FIG. 8 is a vertical sectional view of a fixing device as another variation of the fixing device shown in FIG. 4.

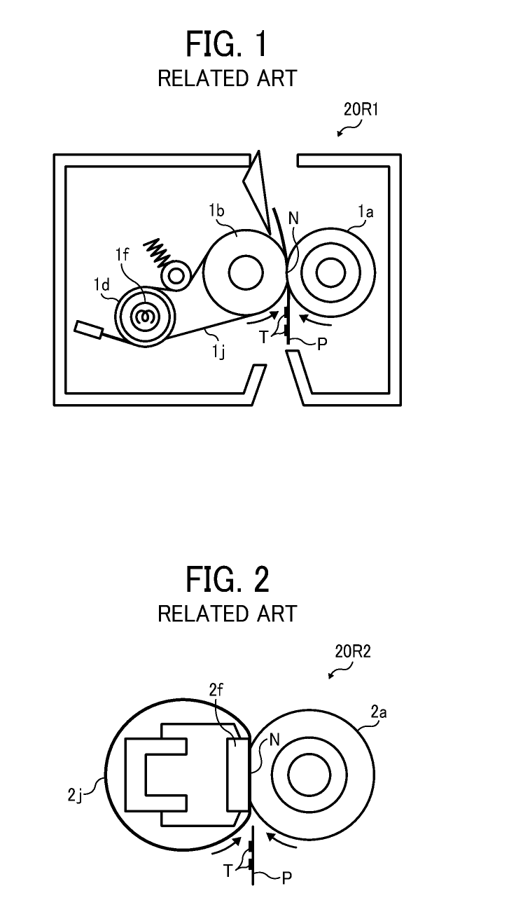

The accompanying drawings are intended to depict example embodiments and should not be interpreted to limit the scope thereof. The accompanying drawings are not to be considered as drawn to scale unless explicitly noted.

### DETAILED DESCRIPTION OF THE INVENTION

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

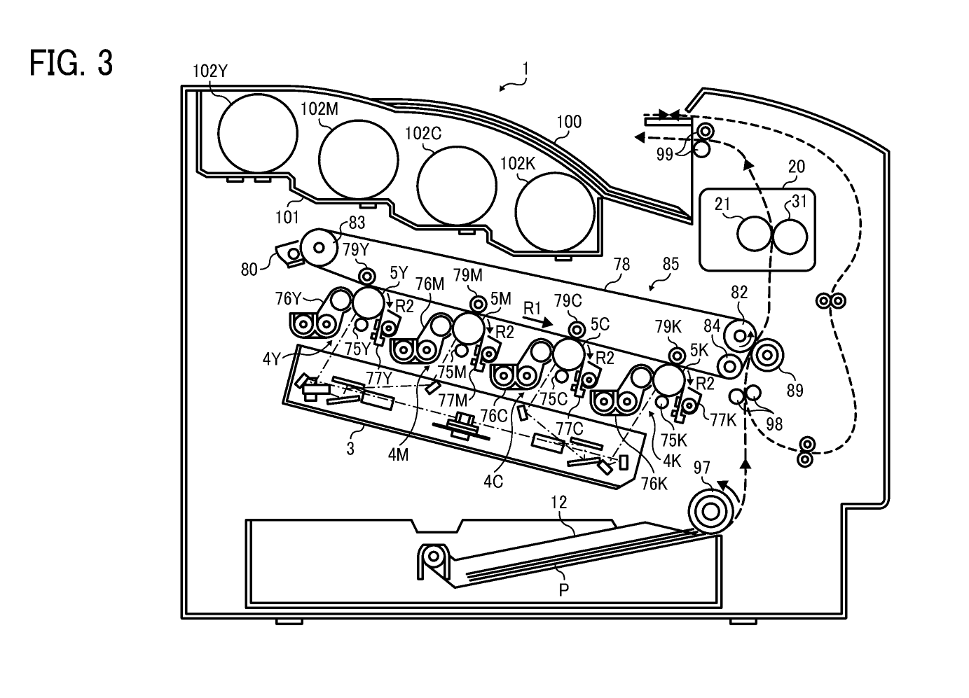

Referring now to the drawings, wherein like reference numerals designate identical or corresponding parts throughout the several views, particularly to FIG. 3, an image forming apparatus 1 according to an example embodiment is explained.

FIG. 3 is a schematic vertical sectional view of the image forming apparatus 1. The image forming apparatus 1 may be a copier, a facsimile machine, a printer, a multifunction printer (MFP) having at least one of copying, printing, scanning, plotter, and facsimile functions, or the like. According to this example embodiment, the image forming apparatus 1 is a tandem color printer that forms a toner image on a recording medium P by electrophotography.

Four toner bottles 102Y, 102M, 102C, and 102K containing yellow, magenta, cyan, and black toners, respectively, are detachably attached to a bottle holder 101 situated in an upper portion of the image forming apparatus 1.

Below the bottle holder 101 is an intermediated transfer unit 85 accommodating an intermediate transfer belt 78 rotatable in a rotation direction R1. The intermediate transfer belt 78 is disposed opposite four image forming devices 4Y, 4M, 4C, and 4K aligned in the rotation direction R1 of the intermediate transfer belt 78 to form yellow, magenta, cyan, and black toner images, respectively. The image forming devices 4Y, 4M, 4C, and 4K include photoconductive drums 5Y, 5M, 5C, and 5K surrounded by chargers 75Y, 75M, 75C, and 75K, development devices 76Y, 76M, 76C, and 76K, cleaners 77Y, 77M, 77C, and 77K, and dischargers, respectively. On the photoconductive drums 5Y, 5M, 5C, and 5K, image forming processes including a charging process, an exposure process, a development process, a primary transfer process, and a cleaning process are performed to form yellow, magenta, cyan, and black toner images on the photoconductive drums 5Y, 5M, 5C, and 5K, respectively.

For example, as a driver (e.g., a motor) drives and rotates the photoconductive drums 5Y, 5M, 5C, and 5K clockwise in FIG. 3 in a rotation direction R2, the chargers 75Y, 75M, 75C, and 75K uniformly charge an outer circumferential surface of the respective photoconductive drums 5Y, 5M, 5C, and 5K in the charging process. Then, an exposure device 3 situated below the image forming devices 4Y, 4M, 4C, and 4K emits laser beams onto the charged outer circumferential surface of the respective photoconductive drums 5Y, 5M, 5C, and 5K according to yellow, magenta, cyan, and black image data sent from an external device such as a client computer, thus forming electrostatic latent images on the photoconductive drums 5Y, 5M, 5C, and 5K, respectively, in the exposure process.

As the electrostatic latent images formed on the photoconductive drums 5Y, 5M, 5C, and 5K reach a position disposed opposite the respective development devices 76Y, 76M, 76C, and 76K, the development devices 76Y, 76M, 76C, and 76K visualize the electrostatic latent images into yellow, magenta, cyan, and black toner images, respectively, in the development process.

Primary transfer bias rollers 79Y, 79M, 79C, and 79K are disposed opposite the photoconductive drums 5Y, 5M, 5C, and 5K, respectively, via the intermediate transfer belt 78. As the yellow, magenta, cyan, and black toner images formed on the photoconductive drums 5Y, 5M, 5C, and 5K reach a position disposed opposite the respective primary transfer bias rollers 79Y, 79M, 79C, and 79K, the primary transfer bias rollers 79Y, 79M, 79C, and 79K primarily transfer the yellow, magenta, cyan, and black toner images onto the intermediate transfer belt 78 in the primary transfer process. After the primary transfer of the yellow, magenta, cyan, and black toner images, residual yellow, magenta, cyan, and black toners in a slight amount failed to be transferred onto the intermediate transfer belt 78 remain on the photoconductive drums 5Y, 5M, 5C, and 5K, respectively. To address this circumstance, a cleaning blade of the respective cleaners 77Y, 77M, 77C, and 77K mechanically removes the residual toners from the respective photoconductive drums 5Y, 5M, 5C, and 5K in the cleaning process.

Finally, the dischargers discharge the outer circumferential surface of the respective photoconductive drums 5Y, 5M, 5C, and 5K, eliminating residual potential from the photoconductive drums 5Y, 5M, 5C, and 5K. Thus, a series of image forming processes performed on the respective photoconductive drums 5Y, 5M, 5C, and 5K is completed. The yellow, magenta, cyan, and black toner images primarily transferred from the photoconductive drums 5Y, 5M, 5C, and 5K onto the intermediate transfer belt 78 are superimposed on a same position on the intermediate transfer belt 78. Thus, a color toner image is formed on the intermediate transfer belt 78.

The intermediate transfer unit 85 includes the intermediate transfer belt 78, the four primary transfer bias rollers 79Y, 79M, 79C, and 79K, a secondary transfer backup roller 82, a cleaning backup roller 83, a tension roller 84, and an intermediate transfer belt cleaner 80. The intermediate transfer belt 78 is stretched across and supported by the three rollers, that is, the secondary transfer backup roller 82, the cleaning backup roller 83, and the tension roller 84. As the secondary transfer backup roller 82 rotates counterclockwise in FIG. 3, it drives and rotates the intermediate transfer belt 78 in the rotation direction R1. The primary transfer bias rollers 79Y, 79M, 79C, and 79K and the photoconductive drums 5Y, 5M, 5C, and 5K sandwich the intermediate transfer belt 78, forming primary transfer nips between the photoconductive drums 5Y, 5M, 5C, and 5K and the intermediate transfer belt 78, respectively. The primary transfer bias rollers 79Y, 79M, 79C, and 79K are applied with a transfer bias having a polarity opposite a polarity of yellow, magenta, cyan, and black toners of the yellow, magenta, cyan, and black toner images formed on the photoconductive drums 5Y, 5M, 5C, and 5K.

As the intermediate transfer belt 78 rotating in the rotation direction R1 travels through the primary transfer nips, the yellow, magenta, cyan, and black toner images are primarily transferred from the photoconductive drums 5Y, 5M, 5C, and 5K onto the intermediate transfer belt 78 in such a manner that the yellow, magenta, cyan, and black toner images are superimposed on the same position on the intermediate transfer belt 78. Thus, the color toner image is formed on the intermediate transfer belt 78. Thereafter, the color toner image formed on the intermediate transfer belt 78 reaches a secondary transfer roller 89. The secondary transfer roller 89 sandwiches the intermediate transfer belt 78 together with the secondary transfer backup roller 82, forming a secondary transfer nip between the secondary transfer roller 89 and the intermediate transfer belt 78. As a recording medium P is conveyed through the secondary transfer nip, the color toner image is secondarily transferred from the intermediate transfer belt 78 onto the recording medium P in a secondary transfer process. After the secondary transfer of the color toner image, residual toner failed to be transferred onto the recording medium P remains on the intermediate transfer belt 78. To address this circumstance, the intermediate transfer belt cleaner 80 removes the residual toner from the intermediate transfer belt 78. Thus, a series of transfer processes, that is, the primary transfer process and the secondary transfer process, performed on the intermediate transfer belt 78 is completed.

The recording medium P is conveyed to the secondary transfer nip from a paper tray 12 situated in a lower portion of the image forming apparatus 1 through a feed roller 97 and a registration roller pair 98. The paper tray 12 loads a plurality of recording media P (e.g., transfer sheets). As the feed roller 97 rotates counterclockwise in FIG. 3, it picks up and feeds an uppermost recording medium P toward a nip formed between two rollers of the registration roller pair 98. As the recording medium P comes into contact with the registration roller pair 98, the registration roller pair 98 that stops its rotation halts the recording medium P temporarily. At a time when the color toner image formed on the intermediate transfer belt 78 reaches the secondary transfer nip, the registration roller pair 98 resumes its rotation to convey the recording medium P toward the secondary transfer nip. Thus, the color toner image is secondarily transferred from the intermediate transfer belt 78 onto the recording medium P. Thereafter, the recording medium P bearing the color toner image is conveyed to a fixing device 20 where a fixing belt 21 and a pressing roller 31 apply heat and pressure to the recording medium P, thus fixing the color toner image on the recording medium P. Then, the recording medium P bearing the fixed color toner image is conveyed to an output roller pair 99 that discharges the recording medium P onto an outside of the image forming apparatus 1, that is, an output tray 100 where the recording medium P is stacked. Thus, a series of image forming processes performed by the image forming apparatus 1 is completed.

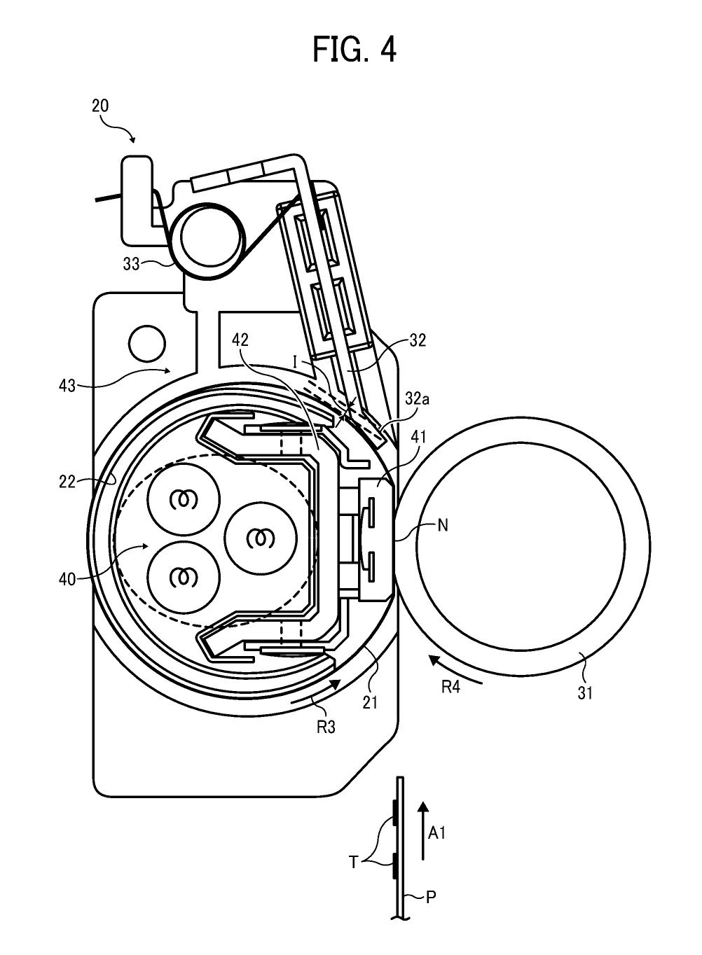

With reference to FIG. 4, a description is provided of a construction of the fixing device 20 according to a first example embodiment of the present disclosure that is incorporated in the image forming apparatus 1 described above.

FIG. 4 is a vertical sectional view of the fixing device 20. As shown in FIG. 4, the fixing device 20 (e.g., a fuser) includes the fixing belt 21 formed into a loop and serving as an endless belt rotatable in a rotation direction R3; the pressing roller 31 serving as a pressing body contacting an outer circumferential surface of the fixing belt 21 and rotatable in a rotation direction R4 counter to the rotation direction R3 of the fixing belt 21; a metal pipe 22 contactably disposed in proximity to an inner circumferential surface of the fixing belt 21; and a heater 40 (e.g., a halogen heater set) disposed inside the loop formed by the fixing belt 21. The heater 40 heats the metal pipe 22 that in turn heats the fixing belt 21. The fixing device 20 further includes a nip formation pad 41 disposed inside the loop formed by the fixing belt 21 and supported by the metal pipe 22. The pressing roller 31 is pressed against the nip formation pad 41 via the fixing belt 21 to form a fixing nip N between the pressing roller 31 and the fixing belt 21. Accordingly, the inner circumferential surface of the fixing belt 21 comes into direct contact with and slides over the nip formation pad 41. Alternatively, the inner circumferential surface of the fixing belt 21 may come into indirect contact with the nip formation pad 41 via a slide sheet and may slide over the slide sheet. According to this example embodiment shown in FIG. 4, the pressing roller 31 and the nip formation pad 41 produce the curved fixing nip N that is concave along an outer circumference of the pressing roller 31. Alternatively, the fixing nip N may be planar or have other shapes. However, the concave fixing nip N is preferable because it facilitates separation of the recording medium P from the fixing belt 21 and thereby prevents jamming of the recording medium P by directing a leading edge of the recording medium P discharged from the fixing nip N toward the pressing roller 31.

A detailed description is now given of a construction of the pressing roller 31.

The pressing roller 31 is constructed of a hollow metal roll; a silicone rubber layer coating the metal roll; and a surface release layer coating the silicone rubber layer. The release layer is made of tetrafluoroethylene-perfluoroalkyl vinyl ether copolymer (PFA) or polytetrafluoroethylene (PTFE) that facilitates separation of the recording medium P from the pressing roller 31. As the pressing roller 31 receives a driving force from a driver (e.g., a motor) located inside the image forming apparatus 1 depicted in FIG. 3 through a gear train, the pressing roller 31 rotates in the rotation direction R4. The pressing roller 31 is pressed by a spring against the nip formation pad 41 via the fixing belt 21. As the spring presses the pressing roller 31 against the nip formation pad 41, the silicone rubber layer of the pressing roller 31 deforms and produces the fixing nip N having a given length in a recording medium conveyance direction A1. Alternatively, the pressing roller 31 may be a solid roller. However, it is preferable that the pressing roller 31 is a hollow roller that has a reduced thermal capacity. If the pressing roller 31 is the hollow roller, a heater such as a halogen heater may be situated inside the pressing roller 31. The silicone rubber layer of the pressing roller 31 may be made of solid rubber. However, it is preferable that the silicone rubber layer is made of sponge rubber if no heater is situated inside the pressing roller 31. In this case, the sponge rubber achieves an enhanced insulation that draws less heat from the fixing belt 21.

A detailed description is now given of a construction of the fixing belt 21.

The fixing belt 21 is a metal belt made of nickel or stainless steel or a sleeve belt or a film made of resin such as polyimide. The fixing belt 21 is constructed of a base layer and a surface release layer. The release layer is made of PFA or PTFE that facilitates separation of toner of a toner image T on a recording medium P. Alternatively, an elastic layer made of silicone rubber may be interposed between the base layer and the release layer. If the pressing roller 31 does not incorporate the elastic layer, the pressing roller 31 has a reduced thermal capacity that improves fixing performance of being heated to a given fixing temperature quickly. However, as the pressing roller 31 and the fixing belt 21 sandwich and press the toner image T on the recording medium P passing through the fixing nip N, slight surface asperities of the fixing belt 21 may be transferred onto the toner image T on the recording medium P, resulting in formation of a faulty solid toner image, that is, an orange peel image. To address this problem, the pressing roller 31 includes the elastic layer having a thickness not smaller than about 100 micrometers. Such relatively thick elastic layer deforms and absorbs slight surface asperities of the fixing belt 21, preventing formation of an orange peel image.

A detailed description is now given of a configuration of the metal pipe 22.

The metal pipe 22 is made of metal such as aluminum, iron, and stainless steel. According to this example embodiment shown in FIG. 4, the metal pipe 22 is substantially circular in cross-section. Alternatively, the metal pipe 22 may be rectangular or may have other shapes. A support 42 supporting the nip formation pad 41 is situated inside a substantial loop formed by the metal pipe 22. The support 42 supports the nip formation pad 41 against pressure from the pressing roller 31, preventing bending of the nip formation pad 41 and thereby facilitating the nip formation pad 41 to produce the even fixing nip N throughout an axial direction of the fixing belt 21. The nip formation pad 41 and the support 42 are mounted on and positioned by a flange 43 at each lateral end of the nip formation pad 41 and the support 42 in a longitudinal direction thereof parallel to the axial direction of the fixing belt 21. The flange 43 also contacts and supports the fixing belt 21 at each lateral end in the axial direction thereof, thus guiding the fixing belt 21 rotating in the rotation direction R3. A surface of the support 42 may be insulated or mirror finished, preventing itself from being heated by heat radiated from the heater 40 and thereby minimizing waste of energy.

According to this example embodiment, the heater 40 includes a plurality of halogen heaters. Alternatively, the heater 40 may be at least one halogen heater, induction heater, resistant heat generator, carbon heater, or the like. According to this example embodiment, the fixing belt 21 is driven and rotated by an external roller, that is, the pressing roller 31. For example, as a driver drives and rotates the pressing roller 31 in the rotation direction R4, the fixing belt 21 is rotated in the rotation direction R3 by a driving force transmitted from the pressing roller 31 at the fixing nip N. Alternatively, a driver is connected to the fixing belt 21 through a gear train and the flange 43 to drive and rotate the fixing belt 21. Yet alternatively, a driver is connected to each of the pressing roller 31 and the fixing belt 21.

The fixing belt 21 is rotated by the pressing roller 31 rotated by the driver by friction between the fixing belt 21 and the pressing roller 31 at the fixing nip N. Conversely, at a position other than the fixing nip N, the fixing belt 21 is guided by the flange 43 so that the rotation locus of the fixing belt 21 is spaced apart from the heater 40 within a given distance. An interface between the fixing belt 21 and the metal pipe 22 is applied with a lubricant such as silicone oil and fluorine grease. Thus, the entire fixing belt 21 is warmed up quickly and maintained at a given temperature stably at reduced costs.

Alternatively, the fixing device 20 may not incorporate the metal pipe 22. If the metal pipe 22 is eliminated, the fixing belt 21 is heated by the heater 40 directly, shortening a warm-up time of the fixing belt 21 and thereby saving energy.

With reference to FIG. 4, a description is provided of a configuration of the flange 43 and a separator 32 coupled with the flange 43.

The flange 43 supports the fixing belt 21 at each lateral end of the inner circumferential surface of the fixing belt 21 in the axial direction thereof in such a manner that the fixing belt 21 is slidable over the flange 43. The flange 43 includes a groove that engages the separator 32 (e.g., a separation plate). Thus, the flange 43 supports the separator 32 through the groove. The nip formation pad 41 situated inside the loop formed by the fixing belt 21 is supported by the support 42. The support 42, the flange 43, and the heater 40 are supported by a belt unit stay mounted on a frame of the fixing device 20. A torsion coil spring 33 serving as a biasing member is interposed between the separator 32 and the flange 43. For example, the torsion coil spring 33 is anchored to the separator 32 and the flange 43 to exert a bias to the separator 32 that constantly biases the separator 32 downward against the fixing belt 21.

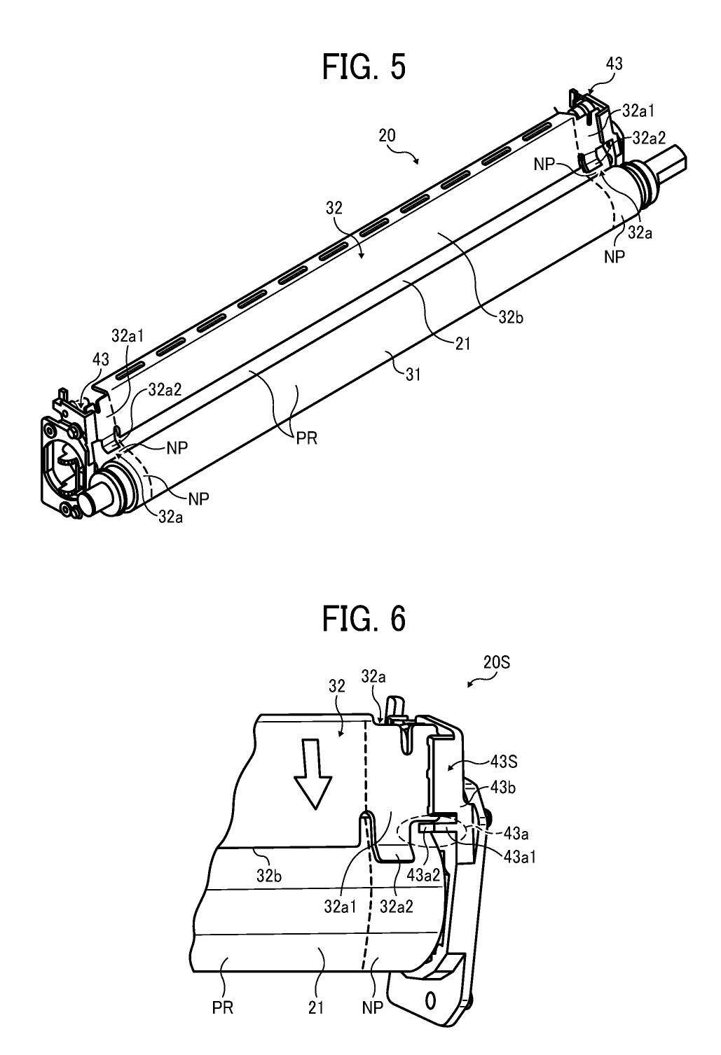

FIG. 5 is a perspective view of the fixing device 20 seen from above the pressing roller 31. As shown in FIG. 5, the separator 32 is constructed of a center plate 32b disposed opposite a center of the fixing belt 21 in the axial direction thereof over which the recording medium P is conveyed and a lateral end plate 32a disposed opposite each lateral end of the fixing belt 21 in the axial direction thereof over which the recording medium P is not conveyed. That is, the center plate 32b is disposed opposite a passage region PR on the outer circumferential surface of the fixing belt 21 where the recording medium P passes.

Conversely, the lateral end plate 32a is disposed opposite a non-passage region NP on the outer circumferential surface of the fixing belt 21 where the recording medium P does not pass. The center plate 32b is integrally molded with the lateral end plates 32a into a unit. The lateral end plate 32a is constructed of a body 32a1 contiguous to the center plate 32b and disposed at each lateral end of the separator 32 in a longitudinal direction thereof parallel to the axial direction of the fixing belt 21 and a contact portion 32a2 projecting from the body 32a1 toward the fixing belt 21. For example, the contact portion 32a2 of the lateral end plate 32a projects beyond the center plate 32b toward the fixing belt 21.

Each of the contact portions 32a2 is constantly in contact with the outer circumferential surface of the fixing belt 21 in the non-passage region NP thereof where the recording medium P does not pass. Thus, the contact portions 32a2 produce a desired interval I depicted in FIG. 4 between the center plate 32b and the fixing belt 21 in the passage region PR thereof where the recording medium P passes. Hence, the interval I facilitates separation of the recording medium P from the fixing belt 21 by the center plate 32b. The torsion coil spring 33 depicted in FIG. 4 exerts a bias to the separator 32 that is great enough to bring each contact portion 32a2 into constant contact with the outer circumferential surface of the fixing belt 21 and small enough to prevent deformation of the fixing belt 21.

With the configuration of the separator 32 described above, the contact portions 32a2 produce the desired constant interval I between the center plate 32b and the fixing belt 21 that facilitates separation of the recording medium P from the fixing belt 21. Accordingly, even if the fixing belt 21 is deformed by fluctuations in operation and environment of the fixing device 20, the contact portions 32a2 constantly produce the desired interval I between the center plate 32b and the fixing belt 21 uniformly in the axial direction of the fixing belt 21, thus preventing failures that may arise as the recording medium P is accidentally wound around the fixing belt 21 or as the center plate 32b accidentally comes into contact with the fixing belt 21.

Since each contact portion 32a2 contacts the fixing belt 21 in the non-passage region NP thereof where the recording medium P does not pass, the contact portion 32a2 does not come into contact with the recording medium P. Accordingly, the contact portion 32a2 does not adversely affect the recording medium P by damaging the recording medium P and obstructing conveyance of the recording medium P, for example, thus facilitating stable separation of the recording medium P from the fixing belt 21. Further, a user can arbitrarily move the separator 32 upward to enlarge the interval I between the separator 32 and the fixing belt 21. Accordingly, even if the recording medium P is jammed between the separator 32 and the fixing belt 21, the user can remove the jammed recording medium P from between the separator 32 and the fixing belt 21 readily by moving the separator 32 upward. Additionally, compared to a configuration in which a separator is rotatably supported by a support shaft mounted on a side plate that supports the flange 43, according to this example embodiment, the separator 32 is supported by the flange 43 that supports the fixing belt 21, positioning the separator 23 relative to the fixing belt 21 more precisely.

With reference to FIG. 6, a description is provided of a configuration of a fixing device 20S according to a second example embodiment of the present disclosure.

FIG. 6 is a partial perspective view of the fixing device 20S. Unlike the fixing device 20 shown in FIG. 5, the fixing device 20S incorporates a flange 43S including a regulator 43a instead of the flange 43 that does not include the regulator 43a.

As shown in FIG. 6, the flange 43S is constructed of a regulator support 43b and the arm-shaped regulator 43a integrally molded with the regulator support 43b and projecting from the regulator support 43b toward the lateral end plate 32a of the separator 32 in the axial direction of the fixing belt 21. Although FIG. 6 illustrates the flange 43S situated at one lateral end of the fixing belt 21 in the axial direction thereof, another flange 43S is situated at another lateral end of the fixing belt 21 in the axial direction thereof. For example, the regulator 43a is constructed of a fixed end 43a1 contiguous to and mounted on the regulator support 43b and a free end 43a2 extending from the fixed end 43a1 toward the lateral end plate 32a of the separator 32. The free end 43a2 is situated in a travel path through which the lateral end plate 32a of the separator 32 moves downward. Thus, the regulator 43a, by contacting the lateral end plate 32a of the separator 32, regulates movement of the separator 32 in a direction to reduce the interval I between the separator 32 and the fixing belt 21. Accordingly, even if the contact portion 32a2 of the separator 32 in contact with the fixing belt 21 is subject to downward movement, the lateral end plate 32a comes into contact with the free end 43a2 of the regulator 43a that regulates or prevents downward movement of the contact portion 32a2. Consequently, the contact portion 32a2 does not press against the fixing belt 21 with substantial pressure, minimizing failures such as damage to the fixing belt 21.

According to the second example embodiment depicted in FIG. 6, the regulator 43a is molded with the regulator support 43b. Alternatively, the regulator 43a may be manufactured separately from the regulator support 43b.

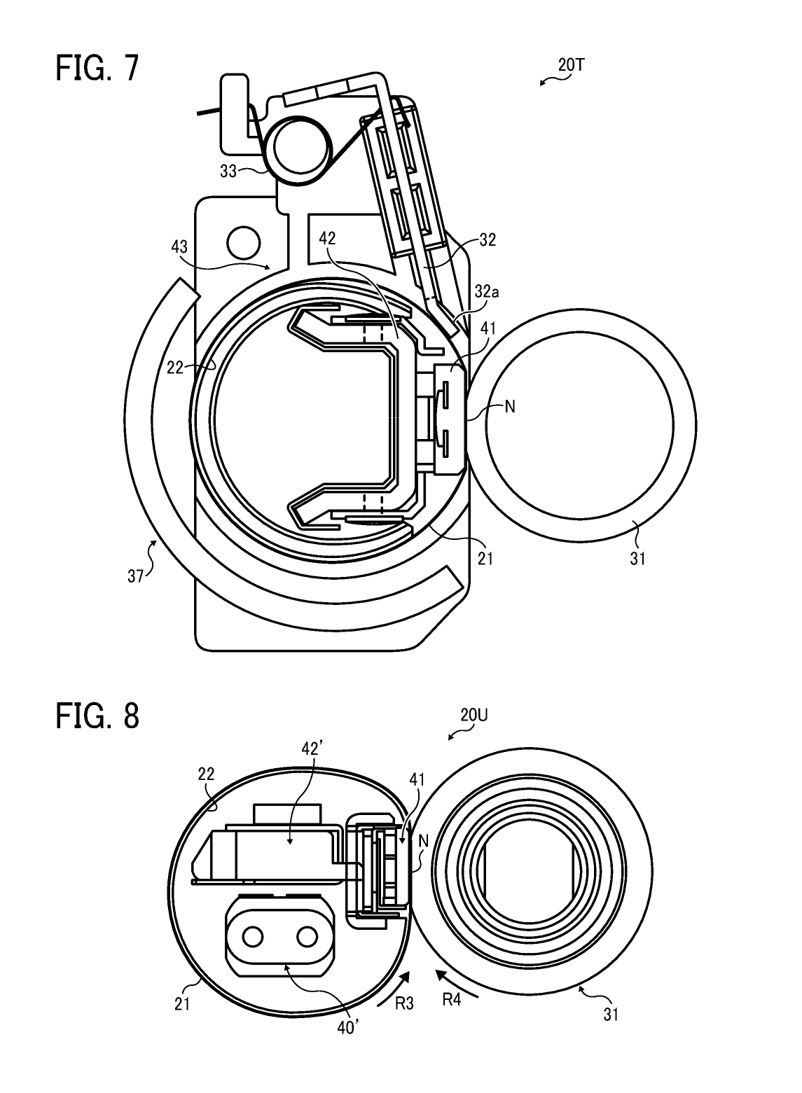

The fixing device 20 depicted in FIG. 4 incorporates the plurality of halogen heaters serving as the heater 40. Alternatively, other heaters may be employed, for example, a ceramic heater disposed opposite the fixing nip N, a flexible laminated heater in contact with the inner circumferential surface of the fixing belt 21, and an induction heater disposed opposite the fixing belt 21 as shown in FIG. 7.

FIG. 7 is a vertical sectional view of a fixing device 20T incorporating an induction heater 37 instead of the heater 40, that is, the halogen heaters, depicted in FIG. 4. As shown in FIG. 7, the induction heater 37 is disposed opposite the outer circumferential surface of the fixing belt 21 to heat the fixing belt 21 by induction heating. Alternatively, the induction heater 37 may be disposed opposite the inner circumferential surface of the fixing belt 21 or both the inner circumferential surface and the outer circumferential surface of the fixing belt 21.

Additionally, the heater 40 incorporated in the fixing device 20 depicted in FIG. 4 is substantially housed by the support 42. Alternatively, a heater may be disposed downstream from a support in the rotation direction R3 of the fixing belt 21 as shown in FIG. 8. FIG. 8 is a vertical sectional view of a fixing device 20U incorporating a heater 40′ disposed downstream from a support 42′ in the rotation direction R3 of the fixing belt 21.

With reference to FIGS. 4 to 8, a description is provided of advantages of the fixing devices 20, 20S, 20T, and 20U described above.

The fixing device (e.g., the fixing devices 20, 20S, 20T, and 20U) includes a flexible endless belt (e.g., the fixing belt 21) rotatable in the rotation direction R3; the nip formation pad 41 contactably disposed opposite the inner circumferential surface of the endless belt; a pressing body (e.g., the pressing roller 31) pressed against the nip formation pad 41 via the endless belt to form the fixing nip N between the pressing body and the endless belt through which a recording medium P bearing a toner image T is conveyed; a flange (e.g., the flanges 43 and 43S) contacting and rotatably supporting the endless belt; and the separator 32 movably supported by the flange to separate the recording medium P discharged from the fixing nip N from the endless belt by contacting the recording medium P. The separator 32 includes the center plate 32b disposed opposite the center of the endless belt in the axial direction thereof and the lateral end plate 32a disposed opposite each lateral end of the endless belt in the axial direction thereof. The lateral end plate 32a includes the contact portion 32a2 projecting beyond the center plate 32b toward the endless belt and contacting the endless belt to produce the given interval I between the center plate 32b and the outer circumferential surface of the endless belt.

With this configuration of the separator 32, the given interval I is retained between the center plate 32b and the outer circumferential surface of the endless belt, facilitating separation of the recording medium P from the endless belt. Accordingly, even if the endless belt is deformed by fluctuations in operation and environment of the fixing device, the contact portions 32a2 constantly produce the desired interval I between the center plate 32b and the endless belt uniformly in the axial direction of the endless belt, thus preventing failures that may arise as the recording medium P is accidentally wound around the endless belt or as the center plate 32b accidentally comes into contact with the endless belt.

According to the example embodiments described above, the pressing roller 31 serves as a pressing body disposed opposite the fixing belt 21. Alternatively, a pressing belt, pressing pad, a pressing plate, or the like may serve as a pressing body.

The present invention has been described above with reference to specific example embodiments. Note that the present invention is not limited to the details of the embodiments described above, but various modifications and enhancements are possible without departing from the spirit and scope of the invention. It is therefore to be understood that the present invention may be practiced otherwise than as specifically described herein. For example, elements and/or features of different illustrative example embodiments may be combined with each other and/or substituted for each other within the scope of the present invention.

What is claimed is:

1. A fixing device comprising:
a flexible endless belt rotatable in a given direction of rotation;
a nip formation pad disposed opposite an inner circumferential surface of the endless belt;
a pressing body pressed against the nip formation pad via the endless belt to form a fixing nip between the pressing body and the endless belt through which a recording medium is conveyed;
a flange contacting and supporting the endless belt; and
a separator movably supported by the flange to contact and separate the recording medium discharged from the fixing nip from the endless belt,
the separator including:
a center plate disposed opposite a center of the endless belt in an axial direction thereof to contact the recording medium; and
a lateral end plate disposed opposite each lateral end of the endless belt in the axial direction thereof and including a contact portion projecting beyond the center plate toward the endless belt and contacting the endless belt to produce a given interval between the center plate and the endless belt.

2. The fixing device according to claim 1,
wherein the lateral end plate of the separator further includes a body contiguous to the center plate, and
wherein the contact portion projects from the body toward the endless belt.

3. The fixing device according to claim 1, wherein the separator is manually moved upward to enlarge the interval between the separator and the endless belt arbitrarily.

4. The fixing device according to claim 1, wherein the contact portion of the lateral end plate of the separator contacts a non-passage region situated at each lateral end of the endless belt in the axial direction thereof where the recording medium is not conveyed.

5. The fixing device according to claim 4, wherein the center plate of the separator is disposed opposite a passage region situated at the center of the endless belt in the axial direction thereof where the recording medium is conveyed.

6. The fixing device according to claim 1, further comprising a biasing member interposed between the separator and the flange, the biasing member to exert a bias to the separator that biases the separator against the endless belt.

7. The fixing device according to claim 6, wherein the biasing member includes a torsion coil spring anchored to the separator and the flange.

8. The fixing device according to claim 1, wherein the flange includes a regulator to contact the separator to regulate movement of the separator in a direction to reduce the interval between the separator and the endless belt.

9. The fixing device according to claim 8,
wherein the flange further includes a regulator support integrally molded with the regulator, and
wherein the regulator projects from the regulator support toward the lateral end plate of the separator in the axial direction of the endless belt to contact the lateral end plate of the separator.

10. The fixing device according to claim 9, wherein the regulator includes:
a fixed end contiguous to the regulator support; and
a free end extending from the fixed end toward the lateral end plate of the separator to contact the lateral end plate of the separator.

11. The fixing device according to claim 1, wherein the center plate of the separator is integrally molded with the lateral end plate of the separator.

12. The fixing device according to claim 1, wherein the endless belt includes one of a sleeve belt and a film.

13. The fixing device according to claim 1, wherein the pressing body includes a pressing roller.

14. An image forming apparatus comprising the fixing device according to claim 1.
